(19) United States
(12) Patent Application Publication
(10) Pub. No.: US 2015/0161070 A1
(43) Pub. Date: Jun. 11, 2015

(54) METHOD AND SYSTEM FOR MANAGING BANDWIDTH DEMAND FOR A VARIABLE BANDWIDTH PROCESSING ELEMENT IN A PORTABLE COMPUTING DEVICE

(71) Applicant: Qualcomm Incorporated, San Diego, CA (US)

(72) Inventors: CRISTIAN DUROIU, SAN DIEGO, CA (US); STEVEN S. THOMSON, SAN DIEGO, CA (US)

(73) Assignee: Qualcomm Incorporated, San Diego, CA (US)

(21) Appl. No.: 14/155,319

(22) Filed: Jan. 14, 2014

Related U.S. Application Data
(60) Provisional application No. 61/912,484, filed on Dec. 5, 2013.

(51) Int. Cl. G06F 13/42

(52) U.S. Cl. CPC G06F 13/42

(57) ABSTRACT

A method and system for managing bandwidth demand for a variable bandwidth processing element in a portable computing device (“PCD”) includes monitoring bandwidth requests of a plurality of constant bandwidth processing elements and monitoring bandwidth requests of a variable bandwidth processing element. The variable bandwidth processing element may be either a graphics processing unit (GPU) or a central processing unit (CPU). The method may include determining if the variable bandwidth processing element needs adjustment to its bandwidth for a bus. Next, a message may be communicated to an aggregate bus driver indicating a level of adjustment for the variable bandwidth processing element. Based on the minimum frequency set for the entire PCD and the level of adjustment for the variable bandwidth processing element, the aggregate bus driver may set a new bandwidth value for the predetermined threshold of the bandwidth limiter for the variable bandwidth processing element.

### RELATED APPLICATIONS STATEMENT

This patent application is a non-provisional of and claims priority under 35 U.S.C. §119(e) to U.S. Provisional Patent Application No. 61/912,484, filed on Dec. 5, 2013, entitled, “METHOD AND SYSTEM FOR MANAGING BANDWIDTH DEMAND FOR A VARIABLE BANDWIDTH PROCESSING ELEMENT IN A PORTABLE COMPUTING DEVICE,” the entire contents of which are hereby incorporated by reference.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

Because PCDs are becoming necessities for people, optimal performance in terms of having sufficient energy to operate a PCD between recharging periods may be a significant factor from a user's perspective. Sufficient energy to operate a PCD on battery power is often dictated by the device's power consumption. And each subcomponent of a PCD, such as a camera and mobile display within a battery-powered PCD, ultimately consumes power and contributes to the overall power consumption and performance of the PCD.

One problem with conventional PCDs is that several master components, such as a graphical processing unit (“GPU”) and a central processing unit (“CPU”), have bus bandwidth consumption which may vary during runtime based on the application programs being executed by each GPU and CPU. If the clock of the entire PCD 100 is set at a high value, then usually most masters with the PCD 100 will execute their respective tasks at the same high clock speed. However, such high clock speeds may have a PCD or GPU execute tasks too quickly and unnecessarily which may waste energy. Energy may be wasted since some tasks may be completed with relatively low processing speeds depending upon the workload provided by a respective task.

Accordingly, what is needed in the art is a method and system for managing bandwidth demand for variable bandwidth masters in a PCD such that the masters may execute tasks at different speeds compared to other core components which may have more predictable bandwidths.

### SUMMARY OF THE DISCLOSURE

A method and system for managing bandwidth demand for a variable bandwidth processing element in a portable computing device (“PCD”) includes monitoring bandwidth requests of a plurality of constant bandwidth processing elements and monitoring bandwidth requests of a variable bandwidth processing element. The variable bandwidth processing element may be either a graphics processing unit (GPU) or a central processing unit (CPU). The method may include determining if the variable bandwidth processing element needs adjustment to its bandwidth for a bus. Next, a message may be communicated to an aggregate bus driver indicating a level of adjustment for the variable bandwidth processing element. Based on the minimum frequency set for the entire PCD and the level of adjustment for the variable bandwidth processing element, the aggregate bus driver may set a new bandwidth value for the predetermined threshold of the bandwidth limiter for the variable bandwidth processing element.

A bandwidth limiter may restrict bandwidth of the variable bandwidth processing element based on a predetermined threshold. The bandwidth limiter may include a hardware element coupled to the bus. Meanwhile, a system performance dynamic monitoring (“SPDM”) module may count bytes over time for bandwidth requests made by the variable bandwidth processing element. The SPDM module may track whether requests for bandwidth from a variable bandwidth processing element made are valid or rejected.

The aggregate bus driver may collect (aggregate) the bandwidth requests from the plurality of constant bandwidth processing elements. Based on the aggregated bandwidth requests, the aggregate bus driver may set a minimum frequency for the bus of the portable computing device.

### BRIEF DESCRIPTION OF THE DRAWINGS

In the figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1A is a functional block diagram illustrating an embodiment of a portable computing device (“PCD”);

FIG. 1B is a front view of an exemplary embodiment of a PCD such as a mobile phone;

FIG. 2 is a functional block diagram illustrating an exemplary system for managing bandwidth demand for variable bandwidth masters in a PCD;

FIG. 3 is a functional block diagram illustrating exemplary functions of the aggregate bus driver illustrated in FIG. 2; and

FIG. 4 is a logical flowchart illustrating a method for managing bandwidth demand for variable bandwidth masters in a PCD.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) and fourth generation (“4G”) wireless technology, greater bandwidth availability has enabled more portable computing devices with a greater variety of wireless capabilities.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) wireless technology, have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, and a laptop computer with a wireless connection, among others.

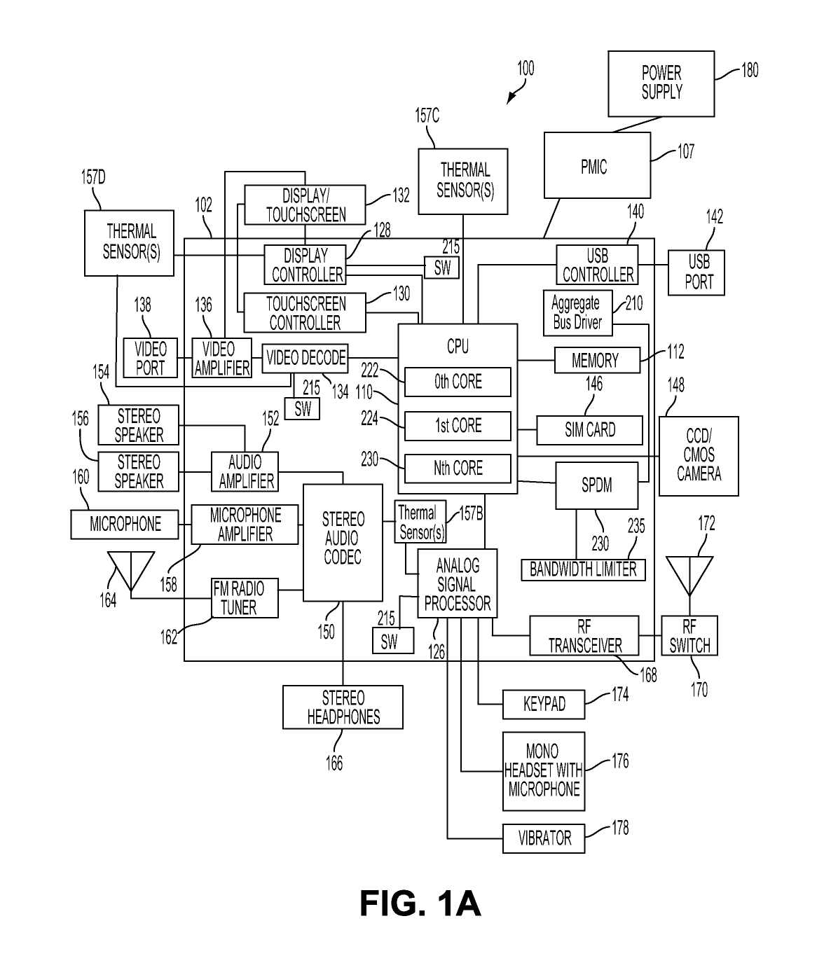

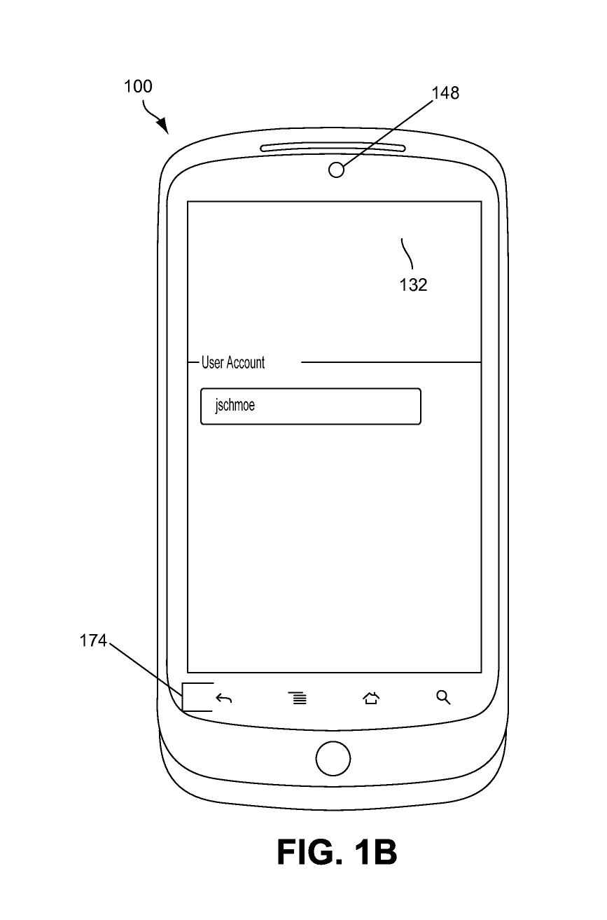

Referring to FIG. 1A, this figure is a functional block diagram of an exemplary, non-limiting aspect of a PCD 100 in the form of a wireless telephone for implementing methods and systems for managing bandwidth demand for variable bandwidth masters in the PCD 100. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Instead of a CPU 110, a digital signal processor (“DSP”) may also be employed as understood by one of ordinary skill in the art.

The CPU 110 may also be coupled to one or more internal, on-chip thermal sensors 157A as well as one or more external, off-chip thermal sensors 157B. The PCD 100 of FIG. 1A may include a limiter 235 that is coupled to a system performance dynamic monitoring (“SPDM”) module 230. The SPDM module 230 may couple directly to the CPU 110. An aggregate bus driver 210 may be coupled with the SPDM module 230.

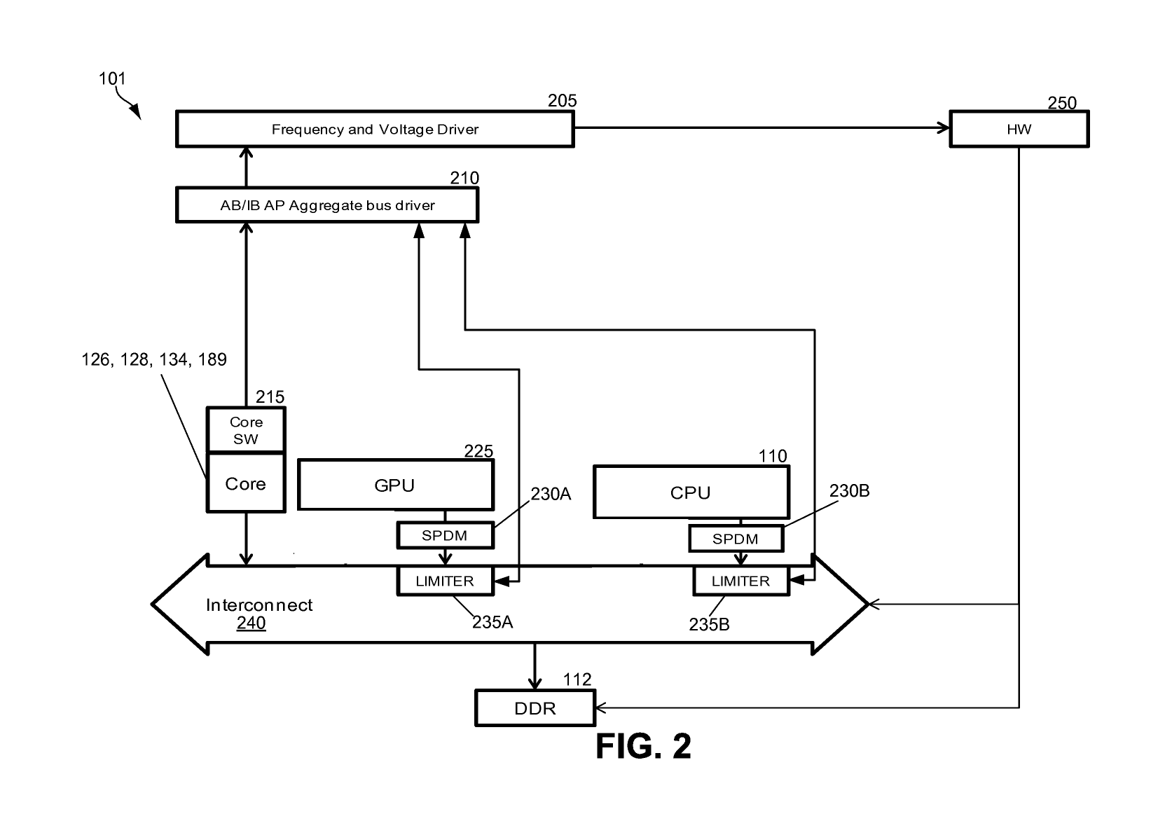

The limiter 235, SPDM module 230, and aggregate bus driver 210 may be responsible for managing the bandwidth of variable masters 110, 225 that may comprise the CPU 110 and its cores 222, 224, 230 as well as a GPU 225 (see FIG. 2). In a particular aspect, one or more of the method steps described herein may be implemented by executable instructions and parameters, stored in the memory, that may form hardware and/or software embodiments of the limiter 235, SPDM module 230, and aggregate bus driver 210. Further, the limiter 235, SPDM module 230, the aggregate bus driver 210, the memory 112, the instructions stored therein, or a combination thereof may serve as a means for performing one or more of the method steps described herein for managing bandwidth demand for variable bandwidth masters in the PCD 100. Further details of the limiter 235, SPDM module 230, and aggregate bus driver 210 will be described in detail below in connection with FIG. 2.

The power manager integrated controller (“PMIC”) 107 may be responsible for distributing power to the various hardware components present on the chip 102. The PMIC is coupled to a power supply 180. The power supply 180, may comprise a battery and it may be coupled to the on-chip system 102. In a particular aspect, the power supply may include a rechargeable direct current (“DC”) battery or a DC power supply that is derived from an alternating current (“AC”) to DC transformer that is connected to an AC power source.

As illustrated in FIG. 1A, a display controller 128 and a touchscreen controller 130 are coupled to the multi-core processor 110. A touchscreen display 132 external to the on-chip system 102 is coupled to the display controller 128 and the touchscreen controller 130.

FIG. 1A is a schematic diagram illustrating an embodiment of a portable computing device (PCD) that includes a video encoder/decoder 134. The video decoder 134 is coupled to the multicore central processing unit (“CPU”) 110. A video amplifier 136 is coupled to the video decoder 134 and the touchscreen display 132. A video port 138 is coupled to the video amplifier 136. As depicted in FIG. 1A, a universal serial bus (“USB”) controller 140 is coupled to the CPU 110. Also, a USB port 142 is coupled to the USB controller 140. A memory 112 and a subscriber identity module (“SIM”) card 146 may also be coupled to the CPU 110.

Further, as shown in FIG. 1A, a digital camera or camera subsystem 148 may be coupled to the CPU 110. In an exemplary aspect, the digital camera/cameral subsystem 148 is a charge-coupled device (“CCD”) camera or a complementary metal-oxide semiconductor (“CMOS”) camera.

As further illustrated in FIG. 1A, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 1A shows that a microphone amplifier 158 may be also coupled to the stereo audio CODEC 150. Additionally, a microphone 160 may be coupled to the microphone amplifier 158.

In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 1A further indicates that a radio frequency (“RF”) transceiver 168 may be coupled to the analog signal processor 126. An RF switch 170 may be coupled to the RF transceiver 168 and an RF antenna 172. As shown in FIG. 1A, a keypad 174 may be coupled to the analog signal processor 126. Also, a mono headset with a microphone 176 may be coupled to the analog signal processor 126. Further, a vibrator device 178 may be coupled to the analog signal processor 126.

As depicted in FIG. 1A, the touchscreen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, and the power supply 180 are external to the on-chip system 102.

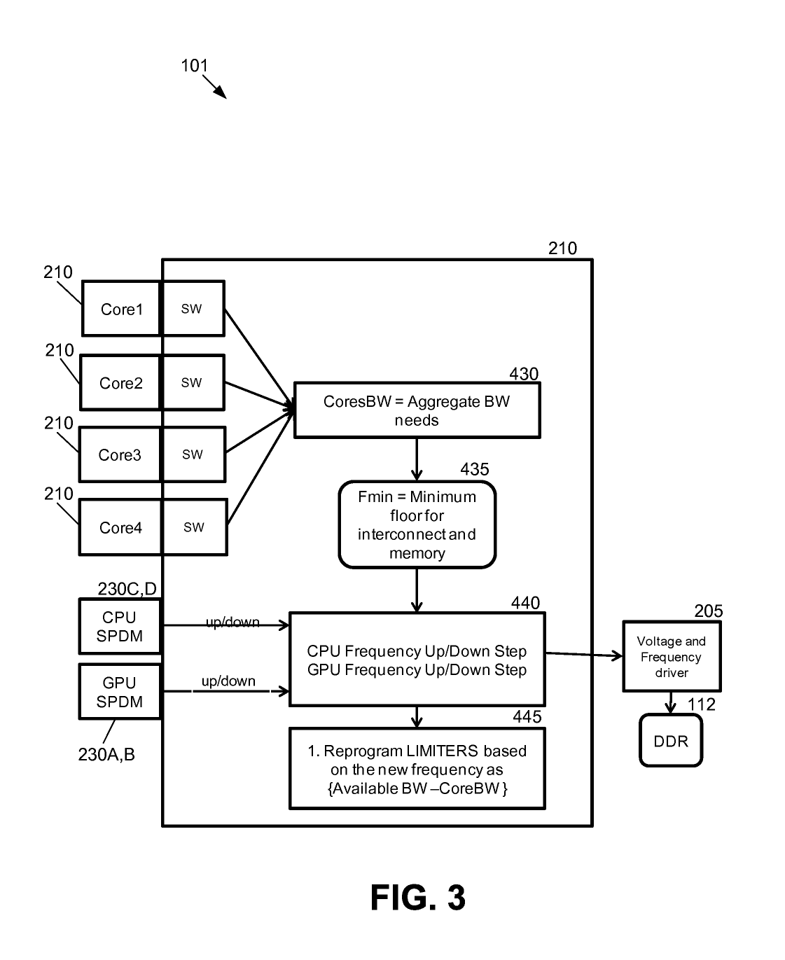

Software components 215 may be coupled to the video encoder 134, analog signal processor 126, and the display controller 128. These software components 215 may communicate bandwidth requests/status messages to the aggregate bus driver 210 as will be described in further detail below in connection with FIG. 3.

Referring now to FIG. 1B, this figure is a front view of one exemplary embodiment of a portable computing device (“PCD”) 100 such as a mobile phone. The PCD 100 has a large touchscreen 132 in its mid-section and smaller keypad/buttons 174 near a lower, first end of the device 100. A “frontward/user” facing camera 148 may be positioned near a top, second end of the device 100. While a touchscreen type mobile phone 100 has been illustrated, other mobile phone types are possible and are within the scope of this disclosure, such as mobile phones 100 that have dedicated key boards which may be placed in a fixed position or which may be slideable inward (in a hidden position) and outward (in a visible/usable position) relative to the device 100.

Referring now to FIG. 2, this figure illustrates a system 101 for managing bandwidth demand for variable bandwidth masters 110, 225 in a PCD 100. Specifically, the system 101 may anticipate/calculate the needs of variable bandwidth demand components, such as masters 110, 225, and adjust capacity for those components in order to conserve power (so that PCD 100 is not running at high clock speeds/frequencies at all times).

Exemplary variable bandwidth masters 110, 225 include, but are not limited, to central processing units 110 and graphical processing units 225. The central processing units 110 may comprise single core CPUs as well as multicore CPUs as understood by one of ordinary skill the art. The system 101 may be generally characterized as a feedback mechanism for monitoring bandwidth demand of predictable/constant core components as well as variable bandwidth components.

Each CPU 110 may be coupled to a system performance dynamic monitor (“SPDM”) 230 and a limiter 235. Similarly, each GPU 225 may be coupled to a system performance dynamic monitor (“SPDM”) 230 and a limiter 235. Each limiter 235 may be coupled to a bus/interconnect/switch fabric 240. The bus 240 of the PCD 100 may also be coupled to predictable bandwidth core components 126, 128, 134, 189.

Predictable bandwidth core components may include, but are not limited to, a video front end (“VFE”) 189, a video encoder 134, the analog signal processor 126 or modem SoC, and a mobile display processor (“MDP”) or controller 128 as described above in connection with FIG. 1 A. These core components 126, 128, 134, 189 of a PCD 100 generally consume a constant amount of bandwidth during run time compared to variable bandwidth masters 110, 225 and they may allow an aggregate bus driver 210 to accurately predict their projected bandwidth consumption.

The aggregate bus driver 210 may be coupled to software components 215 which monitor bandwidth requests for each respective core component 126, 128, 134, 189. The aggregate bus driver 210 may also be coupled to each respective limiter 235 for receiving bandwidth request data as well as for sending new thresholds for each respective limiter 235 as will be described in further detail below.

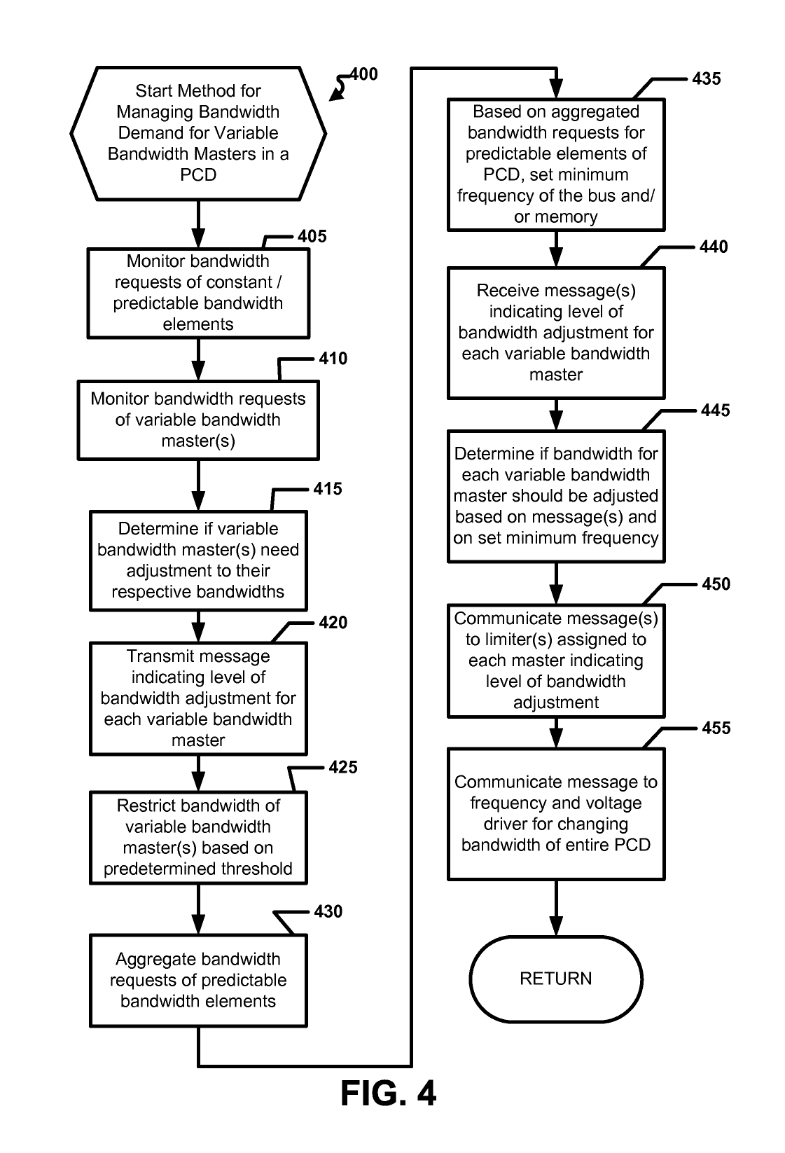

The aggregate bus driver 210 is generally responsible for setting the bandwidth for the entire PCD 100 as well as setting the bandwidth thresholds for predictable bandwidth core components 126, 128, 134, 189 as well as the bandwidth limits present within each limiter 235 coupled to a respective a SPDM 230. Further details about the aggregate bus driver 210 and its functions will be described in more detail below, especially in connection with FIGS. 3-4.

The aggregate bus driver 210 may also be coupled to a frequency and voltage driver 205. The frequency and voltage driver 205 may be coupled to hardware 250. The hardware 250 may comprise a clock for the entire PCD 100. The clock 250 may be coupled to the bus 240 as well as memory elements 112, which may comprise double data rate (“DDR”) memory as understood by one of ordinary skill the art.

The feedback system 101 illustrated in FIG. 2 may comprise at least two components: a limiter 235 and system performance dynamic monitor (“SPDM”) 230. The limiter 235 and SPDM 230 form an adaptive feedback mechanism in which the limiter 235 limits the maximum available capacity for a given node, such as a CPU 110 or GPU 225. The limiter 235 may count bytes over time for bandwidth requests made by a client/node, like a CPU and GPU. If a request exceeds the threshold or limit set by the limiter 235, then the limiter 235 will fault the request so that a request is rejected or receives the not ready message. Meanwhile, it is possible that a slave, such as DDR memory 112, may have sufficient bandwidth to process the request over the bus 240.

The limiter 235 usually comprises hardware programmed by software to limit the amount of bandwidth of a bus 240 consumed by a master, such as a GPU 225 or CPU 110. The limiter 235 could comprise software or firmware, however, in most cases/scenarios, the limiter 235 is usually made of hardware because of the response time needed to manage its data. Response time for the limiter 235 is often measured in tens of nanoseconds for exemplary environments, such as SoCs 102 within mobile telephones 101. The limiter 235 may monitor the present or available bandwidth of a bus 240 for its master—like a CPU 110 or GPU 225.

As noted above, the limiter 235 is coupled to a system performance dynamic monitoring (“SPDM”) module 230. The SPDM module 230 usually comprises hardware which performs calculations on the data it receives from the limiter 235. The SPDM module 230 filters and accumulates data over time to determine frequency/behavior over time compared to a predetermined threshold. The SPDM module 230 monitors how many times its client/master asks/requests for more bandwidth and how many times the client/master is rejected/denied: whether the requests for bandwidth made are valid or rejected/not ready. The SPDM 230 monitors demand and if the demand is below or above available capacity and below or above the bandwidth permitted by the limiter 235.

One implementation of the SPDM 230 module is described in commonly owned U.S. Pat. No. 8,352,759, the entire contents of which are hereby incorporated by reference. However, the SPDM 230 in U.S. Pat. No. 8,552,759 is not described as working with a limiter 235 as described in this disclosure for managing bandwidth of variable bandwidth masters 110, 225.

The SPDM module 230 may send a message or vote to software (to the bus driver 210 via the limiter 235) to indicate if more bandwidth is needed or less bandwidth is needed for its client, which may be a CPU 110 or GPU 225. The aggregate bus driver 210 monitors the bandwidth for the entire system 101 and assigns the limits/thresholds which are transmitted to the limiters 235. For example, the aggregate bus driver 210 could set a limit for a particular limiter 235 to a value such as one-hundred megabytes per second.

As illustrated in FIG. 2, typically, the aggregate bus driver 210 may also monitor bandwidth requests received by software 215 coupled to core or consistent/constant bandwidth consuming core components, such as a mobile display processor/controller 128, a VFE 189, and a video encoder 134. These consistent bandwidth consuming components will be characterized as the “core” of the system 101.

The aggregate bus driver 210 may sum or add up the total bandwidth for the core components of the system 101 and then compare that total bandwidth calculation to the requests the bus driver 210 receives from the SPDM modules 230 coupled to masters, like the CPU 110 and GPU 225. Based on the requests from the SPDM modules 230, the aggregate bus driver 210 may calculate the remaining bandwidth of the system 101 that should be allocated for each master, like the CPU 110 and GPU 225. The aggregate bus driver 210 may then communicate at least one of two types of messages: a message for new limits to each limiter 235 and a message to the frequency and voltage driver 205 for the overall system bandwidth needed. Usually, the aggregate bus driver 210 sends its messages for reprogramming each limiter 235 for lowering bandwidths for a particular master prior to sending its message to the voltage and frequency driver 205 for lowering overall total bandwidth of the system 101.

The frequency and voltage driver 205, after receiving a message from the aggregate bus driver 210 sets the actual frequency of hardware 250, such as a clock, existing within the system 101.

Referring now to FIG. 3, this figure is a functional block diagram illustrating some high-level functions of the aggregate bus driver 210 of FIG. 2. In functional block 430, the aggregate bus driver 210 may receive the bandwidth requests from each software component 215 which is coupled to a respective constant/predictable bandwidth core element, such as the VFE 215A, video encoder 134, signal processor 126, and display controller 128. In this block 430, the aggregate bus driver 210 is “aggregating” the bandwidth requests of the predictable bandwidth components of the PCD 100.

In block 435, based on the aggregation and observation in block 430, the aggregate bus driver 210 may set the minimum “floor” or baseline clock frequency for the bus 240 and memory 112. In block 440, the aggregate bus driver 210 may receive and process messages indicating a level of bandwidth adjustment for each respective variable bandwidth master 110, 225.

In block 445, based on the review of bandwidth requests in block 440 from variable bandwidth masters, the aggregate bus driver may reprogram each limiter 235 based on a calculated new frequency. Typically, the calculated new bandwidth for each limiter 235 may equal the total amount of bandwidth available within the PCD 100 minus the bandwidth allocated for the total bandwidth across the constant/predictable bandwidth components, such as, but not limited to, the VFE 215A, video encoder 134, signal processor 126, and display controller 128.

After the new bandwidth for each limiter 235 is set, the aggregate bus driver 210 may communicate the overall new frequency for the entire system 101 to the voltage and frequency driver 205. The voltage and frequency driver 205 may communicate the overall new frequency to the hardware 250, which may comprise a clock and/or memory 112.

Referring now to FIG. 4, this figure illustrates a method 400 for managing bandwidth demand for variable bandwidth masters in a portable computing device (“PCD”) 100 according to one exemplary embodiment. Block 405 is the first step of method 400. In block 405, the aggregate bus driver 210 may monitor the bandwidth requests of constant bandwidth/predictable core components of the PCD 100. A bandwidth request generally comprises a component of a PCD 100 requesting for at least one of: more memory consumption, an increase in communication volume and/or increase of speed across the communication bus or interconnect 240.

Exemplary predictable bandwidth core components of a PCD 100 may include, but are not limited to, a video front end (“VFE”) 189, a video encoder 134, the analog signal processor 126 or modem SoC, and a mobile display processor (“MDP”) or controller 128. These core components of a PCD 100 generally consume a constant amount of bandwidth during run time and may allow the aggregate bus driver 210 to accurately predict their projected bandwidth consumption.

Next, in block 410, each limiter 235 may monitor the bandwidth requests of its assigned variable bandwidth master 110, 225 of the portable computing device 100. As noted above, variable bandwidth masters 110, 225 may comprise a central processing unit 110, and a graphical processing unit 225. However, other variable bandwidth masters 110, 225 exist and are within the scope of this disclosure. Variable bandwidth masters 110, 225 typically include components of a portable computing device 100 in which their bandwidth demand may vary significantly over time and hence make them less predictable compared to other core components, such as the VFE 189, the video encoder 134, the analog signal processor 126, and the MDP 128 described above. Each variable bandwidth master 110, 225 is usually provided with a limiter 235 described above in connection with FIG. 2.

Next, in block 415, each limiter 235, based on its respective SPDM 230, may determine if its respective variable bandwidth master of the PCD 100 needs adjustment to its respective and individual bandwidth allocation. As noted previously, each SPDM 230 may send a message or vote to software (to the bus driver 210 via the limiter 235) to indicate if more bandwidth is needed or less bandwidth is needed for its client, which may be a CPU 110 or GPU 225. Subsequently, in block 420, each limiter 235 may transmit a message indicating a level of bandwidth adjustment for its respective variable bandwidth master 110, 225 (based on the vote received from the SPDM 230).

In parallel with blocks 405-420, each limiter 235 may restrict the bandwidth of its variable bandwidth master 110, 225 based on a predetermined threshold that is programmable within the limiter 235. When a bandwidth request exceeds the predetermined threshold, a limiter 235 may reject or fault a particular bandwidth request made by a variable bandwidth master 110, 225.

Next, in block 430, the aggregate bus driver 210 may collect or aggregate the bandwidth requests made from the predictable core components of the PCD 100, such as such as the VFE 189, the video encoder 134, the analog signal processor 126, and the MDP 128 described above. Next, in block 435, based on the aggregated bandwidth requests for the predictable core components of the PCD 100, the aggregate bus driver 210 may set or establish the minimum frequency of the bus 240 as well as any memory components 112.

In parallel with blocks 405-415, 425, 430, and 435, in block 440, the aggregate bus driver 210 may receive messages from each limiter 235 indicating respective levels of bandwidth adjustment for each respective variable bandwidth master 110, 225. Next, in block 445, the aggregate bus driver 210 may determine if the bandwidth for a respective variable bandwidth master 110, 225 should be adjusted based on a review of the messages received from a respective limiter 235 for a particular variable bandwidth master 110, 225 and in view of the aggregate bandwidth for the core components evaluated in blocks 430 and 435. Also in this block 445, the aggregate bus driver 210 may also determine the bandwidth for the entire PCD 100 based on the bandwidth allocated for the core components as well as the bandwidth allocated for the variable bandwidth masters 110, 225.

Subsequently, in block 450, the aggregate bus driver 210 may transmit messages to respective limiters 235 indicating levels of adjustment for respective bandwidth limits of a particular variable bandwidth master 110, 225. In this block 450, the message may comprise a new threshold value for increased bandwidth, a new threshold value for decreased bandwidth, or a threshold value that keeps the present threshold value constant for a particular bandwidth limiter 235.

After block 450, in block 455, the aggregate bus driver 210 may communicate a message to the frequency and voltage driver 205 that indicates the bandwidth level for the entire PCD 100. This message may comprise a new threshold value for increased bandwidth, a new threshold value for decreased bandwidth, where threshold value that keeps the present threshold value constant for the entire PCD 100. The method 400 then returns back to block 405.

Regarding the sequence/order/flow for blocks 450 and 455, when there is an increase in frequency for the entire system 101 and an increase in bandwidth for one or more limiters 235, then the message in block 455 for increasing the frequency of the entire system 101 is sent first prior to the message in block 450 for increasing the bandwidth of one or more limiters 230. In other words, blocks 450 and 455 are reversed when there is both a increase in frequency for the system 101 and bandwidth for one or more limiters 230 as understood by one of ordinary skill in the art.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium.

In the context of this document, a computer-readable medium is an electronic, magnetic, optical, or other physical device or means that may contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may include any means that may store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

Computer-readable media include both computer storage media and communication media including any medium that facilitates transfer of a computer program from one place to another. A storage media may be any available media that may be accessed by a computer. By way of example, and not limitation, such computer-readable media may comprise any optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for managing bandwidth demand for a variable bandwidth processing element in a portable computing device, the method comprising:
monitoring bandwidth requests of a plurality of constant bandwidth processing elements;
monitoring bandwidth requests of a variable bandwidth processing element;
determining if the variable bandwidth processing element needs adjustment to its bandwidth for a bus;
communicating a message indicating a level of adjustment for the variable bandwidth processing element;
restricting bandwidth of the variable bandwidth processing element based on a predetermined threshold;
aggregating the bandwidth requests of the plurality of constant bandwidth processing elements;
based on the aggregated bandwidth requests, setting a minimum frequency for the bus of the portable computing device; and
based on the minimum frequency and the level of adjustment for the variable bandwidth processing element, setting a new bandwidth value for the predetermined threshold of the variable bandwidth processing element.

2. The method of claim 1, wherein the variable bandwidth processing element comprises at least one of a graphics processing unit (GPU) and a central processing unit (CPU).

3. The method of claim 1, wherein the portable computing device comprises a plurality of variable bandwidth processing elements.

4. The method of claim 1, further comprising communicating the new bandwidth value for the predetermined threshold to a bandwidth limiter coupled to the variable bandwidth processing element.

5. The method of claim 4, wherein the bandwidth limiter comprises a hardware element coupled to the bus.

6. The method of claim 5, wherein monitoring bandwidth requests of a variable bandwidth processing element further comprises counting bytes over time with the limiter for bandwidth requests made by the variable bandwidth processing element.

7. The method of claim 1, wherein monitoring bandwidth requests of a variable bandwidth processing element further comprises tracking whether the requests for bandwidth made are valid or rejected.

8. The method of claim 1, further comprising communicating the minimum frequency of the bus to a voltage and frequency driver.

9. The method of claim 1, wherein each of the plurality of constant bandwidth processing elements comprises at least one of a video front end (“VFE”), a video encoder, an analog signal processor, a modem SoC, a mobile display processor, and mobile display controller.

10. A system for managing bandwidth demand for a variable bandwidth processing element in a portable computing device, the system comprising:
means for monitoring bandwidth requests of a plurality of constant bandwidth processing elements;
means for monitoring bandwidth requests of a variable bandwidth processing element;
means for determining if the variable bandwidth processing element needs adjustment to its bandwidth for a bus;
means for communicating a message indicating a level of adjustment for the variable bandwidth processing element;
means for restricting bandwidth of the variable bandwidth processing element based on a predetermined threshold;
means for aggregating the bandwidth requests of the plurality of constant bandwidth processing elements;
means for based on the aggregated bandwidth requests, setting a minimum frequency for the bus of the portable computing device; and
means for setting a new bandwidth value for the predetermined threshold of the variable bandwidth processing element based on the minimum frequency and the level of adjustment for the variable bandwidth processing element.

11. The system of claim 10, wherein the variable bandwidth processing element comprises at least one of a graphics processing unit (GPU) and a central processing unit (CPU).

12. The system of claim 10, wherein the portable computing device comprises a plurality of variable bandwidth processing elements.

13. The system of claim 10, further comprising means for communicating the new bandwidth value for the predetermined threshold to a bandwidth limiter coupled to the variable bandwidth processing element.

14. The system of claim 13, wherein the bandwidth limiter comprises a hardware element coupled to the bus.

15. The system of claim 10, wherein each of the plurality of constant bandwidth processing elements comprises at least one of a video front end (“VFE”), a video encoder, an analog signal processor, a modem SoC, a mobile display processor, and mobile display controller.

16. A system for managing bandwidth demand for a variable bandwidth processing element in a portable computing device, the system comprising:
an aggregate bus driver for monitoring bandwidth requests of a plurality of constant bandwidth processing elements, for aggregating the bandwidth requests of the plurality of constant bandwidth processing elements; based on the aggregated bandwidth requests from the constant bandwidth processing elements and a variable bandwidth processing element, the aggregate bus driver setting a minimum frequency for the bus of the portable computing device; based on the minimum frequency and the level of adjustment for the variable bandwidth processing element, setting a new bandwidth value for the predetermined threshold of the variable bandwidth processing element; and
a limiter module for monitoring bandwidth requests of a variable bandwidth processing element, for determining if the variable bandwidth processing element needs adjustment to its bandwidth for a bus, for communicating a message indicating a level of adjustment for the variable bandwidth processing element, and for restricting bandwidth of the variable bandwidth processing element based on a predetermined threshold.

17. The system of claim 16, wherein the variable bandwidth processing element comprises at least one of a graphics processing unit (GPU) and a central processing unit (CPU).

18. The system of claim 16, wherein the portable computing device comprises a plurality of variable bandwidth processing elements.

19. The system of claim 16, wherein the aggregate bus driver communicates the new bandwidth value for the predetermined threshold to the limiter module coupled to the variable bandwidth processing element.

20. The system of claim 16, wherein the limiter module comprises a hardware element coupled to the bus.
